(19) United States
(12) Patent Application Publication
(10) Pub. No.: US 2019/0095867 A1
(43) Pub. Date: Mar. 28, 2019

(54) PORTABLE INFORMATION TERMINAL AND INFORMATION PROCESSING METHOD USED IN THE SAME

(71) Applicant: MAXELL, LTD., Kyoto (JP)

(72) Inventors: Hideo NISHIJIMA, Oyamazaki (JP); Hiroshi SHIMIZU, Oyamazaki (JP); Yasunobu HASHIMOTO, Oyamazaki (JP)

(21) Appl. No.: 16/080,920

(22) PCT Filed: Mar. 9, 2016
(86) PCT No.: PCT/JP2016/057387

§ 371 Date: Aug. 29, 2018

(51) Int. Cl. G06Q 10/10; G06Q 10/06; G06K 9/00; G10L 17/00; G10L 17/26

(52) U.S. Cl. CPC G06Q 10/109; G06Q 10/063; G10L 17/26; G10L 17/005; G06K 9/00288

(57) ABSTRACT

The purpose of the present invention is to provide a portable information terminal and method which comprise a function which more rapidly provides information to a user about a talking partner. To solve the problem, the present invention provides a portable information terminal which is configured to comprise: an input sensor which detects a change in the vicinity thereof; a communication unit which transmits information to and receives information from an external processing device; an output unit which outputs the information; and a control unit which senses a prescribed situation from an input signal change from the input sensor, transmits an instruction signal via the communication unit to the external processing device, receives, from the external processing device via the communication unit, information about a person based on the instruction signal, and outputs the information about the person via the output unit.

### CROSS REFERENCE TO RELATED APPLICATIONS

This patent application is the U.S. National Phase under 35 U.S.C. § 371 of International Application No. PCT/JP2016/057387, filed on Mar. 9, 2016, the entire contents are hereby incorporated by reference.

### TECHNICAL FIELD

The present invention relates to a portable information terminal and an information processing method, which are capable of providing information of a person whom a user performs a conversation with in a direct face-to-face manner.

### BACKGROUND ART

In a case in which we perform a conversation with a person in a direct face to face manner, we are likely to forget information of the person whom we do not often meet. Therefore, although we meet a person directly, we may not remember information about the person. For this reason, a method of describing and recording information of many friends or relevant people in a personal notebook or the like is used, but there are still cases in which the information is unable to be linked with the person.

Recently, people often carry an information terminal having electronic information with facial pictures, check information of a talking partner in advance before a meeting, update a memory, and prepare for the meeting. However, when a person encounters another person suddenly, it does not function as a useful tool at all.

With the advance in face recognition technology and the spread of small-sized cameras or information terminals, new countermeasures using these technologies have been proposed. For example, a technique of a person recognition device and method is disclosed in JP 2014-182480A (Patent Document 1).

### CITATION LIST

### Patent Document

Patent Document 1: JP 2014-182480A

### SUMMARY OF THE INVENTION

### Problems to be Solved by the Invention

A device including an image input means that receives image data, a face detection means that detects a face region in which a face of a person is shown from the received image data, a face feature quantity detecting means that detects a feature quantity of a face from the detected face region, a storage unit that stores person information including information indicating a feature of a face of a person for each person, an extracting means that extracts a person on the basis of the stored person information in a descending order of similarities with the feature quantity of the face in which the stored feature of the face of the person is detected, a candidate count calculating means that calculates the number of candidates to be candidates in a descending order of persons extracted in the descending order of similarities on the basis of an imaging condition of the detected face region, and an output means that outputs person information which is equal in number to the number of candidates calculated in the descending order of persons extracted in the descending order of similarities is disclosed in Patent Document 1.

However, in the technique disclosed in Patent Document 1, even in a case in which a person having a highest similarity is recognized as a specific person, a method of using that information is not taken into consideration. Further, no consideration is given to, for example, an application of carrying the device, specifying a person who is encountered suddenly, easily acquiring information of a talking partner who is encountered, and performing necessary information exchange by a conversation.

The present invention was made in light of the foregoing, and it is an object of the present invention to provide a portable information terminal including a unit that promptly provides information of a talking partner and a method thereof.

### Solutions to Problems

In order to solve the above problems, the present invention provides a portable information terminal including an input sensor that detects a change in surroundings, a communication unit that performs transmission and reception of information with an external processing device, an output unit that outputs information, and a control unit that detects a predetermined situation from a change in an input signal change from the input sensor, transmits an instruction signal to the external processing device via the communication unit, receives information of a person corresponding to the instruction signal from the external processing device via the communication unit, and outputs the information of the person via the output unit.

### Effects of the Invention

According to the present invention, it is possible to provide a portable information terminal including a function of promptly providing information of a talking partner and a method thereof.

### BRIEF DESCRIPTION OF THE DRAWINGS

FIG. 1 is a configuration diagram of a communication system including a portable information terminal according to a first embodiment.

FIG. 2 is a block diagram of a portable information terminal according to the first embodiment.

FIG. 3 is a block diagram of an external processing device according to the first embodiment.

FIG. 4 is a configuration diagram of a communication system including a portable information terminal according to a second embodiment.

FIG. 5 is a block diagram of a portable information terminal according to the second embodiment.

FIG. 6 is an explanatory functional diagram of an information processing unit according to a third embodiment.

FIG. 7 is an explanatory diagram of a face recognition method of an information processing unit according to the third embodiment.

FIG. 8 is an explanatory diagram of a person determination method of the information processing unit according to the third embodiment.

FIG. 9 is an explanatory diagram of a voice recognition method of an information processing unit according to a fourth embodiment.

FIG. 10 is an explanatory diagram of a voice recognition application example of the information processing unit according to the fourth embodiment.

FIG. 11 is an explanatory diagram of a voice recognition application example of the information processing unit according to the fourth embodiment.

FIG. 12 is an explanatory diagram of a voice recognition application example of the information processing unit according to the fourth embodiment.

FIG. 13 is a screen display example of a portable information terminal and an external processing device according to a fifth embodiment.

FIG. 14 is a screen display example of a portable information terminal and an external processing device according to the fifth embodiment.

FIG. 15 is a data diagram of screen display information of a portable information terminal and an external processing device according to the fifth embodiment.

FIG. 16 is a screen display example of a portable information terminal and an external processing device according to the fifth embodiment.

FIG. 17 is an operation flowchart of a portable information terminal according to a sixth embodiment.

FIG. 18 is another operation flowchart of the portable information terminal according to the sixth embodiment.

FIG. 19 is a processing flowchart for acquiring personal information of an talking counterpart using a terminal manipulation of a portable information terminal according to a seventh embodiment as a trigger.

FIG. 20 is a processing flowchart for acquiring individual information of an talking counterpart using approach of another portable information terminal to a portable information terminal according to the seventh embodiment as a trigger.

FIG. 21 is an external configuration diagram of a portable information terminal and an external processing device according to an eighth embodiment.

FIG. 22 is an external configuration diagram of the portable information terminal and the external processing device according to the eighth embodiment.

FIG. 23 is an external configuration diagram of the portable information terminal and the external processing device according to the eighth embodiment.

FIG. 24 is an external configuration diagram of the portable information terminal according to the eighth embodiment.

FIG. 25 is an external configuration diagram of the portable information terminal according to the eighth embodiment.

FIG. 26 is an external configuration diagram of the portable information terminal according to the eighth embodiment.

FIG. 27 is an external configuration diagram of the portable information terminal according to the eighth embodiment.

FIG. 28 is another external configuration diagram of the portable information terminal according to the eighth embodiment.

FIG. 29 is another external configuration diagram of the portable information terminal according to the eighth embodiment.

FIG. 30 is another external configuration diagram of the portable information terminal according to the eighth embodiment.

### MODE FOR CARRYING OUT THE INVENTION

Hereinafter, exemplary embodiments of the present invention will be described with reference to the appended drawings. First embodiment

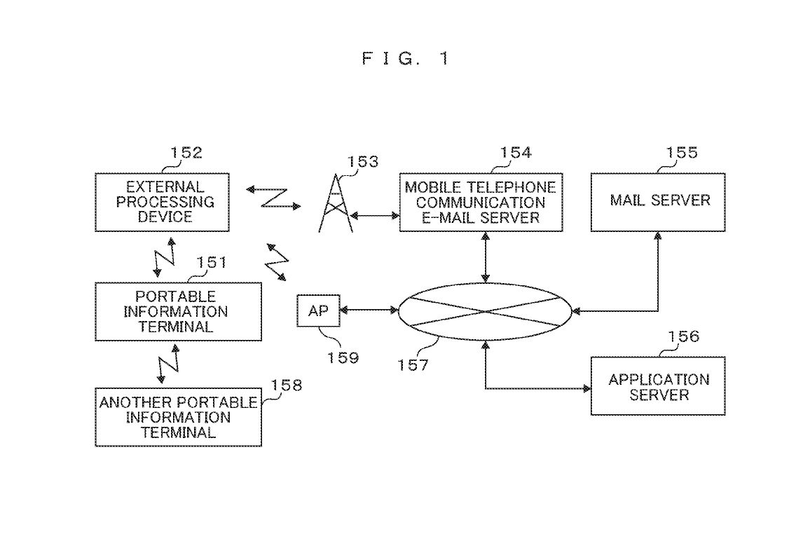

FIG. 1 is an example of a communication system including a portable information terminal 151 in the present embodiment, and the communication system includes an external processing device 152, a base station 153 of a mobile telephone communication network, a mobile telephone communication e-mail server 154, an Internet e-mail server 155, an application server 156, a public network 157, another portable information terminal 158, and a wireless communicator access point 159.

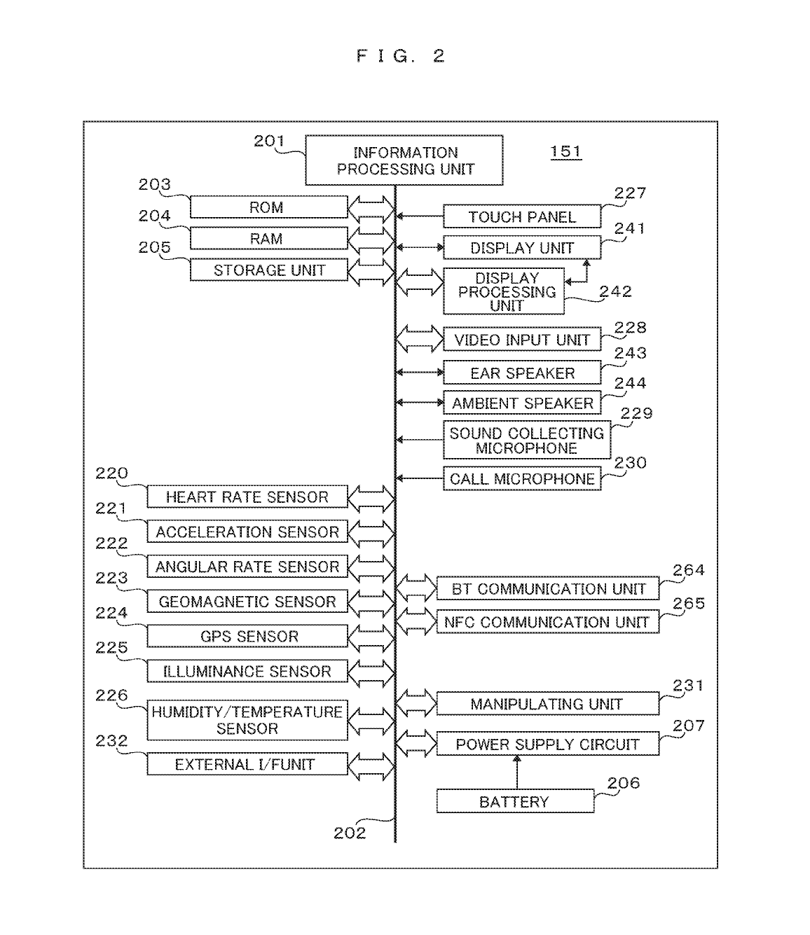

FIG. 2 is a block diagram of the portable information terminal 151 in the communication system of FIG. 1. In FIG. 2, the portable information terminal 151 includes an information processing unit 201, a system bus 202, a read only memory (ROM) 203, a random access memory (RAM) 204, a storage unit 205, a heart rate sensor 220, an acceleration sensor 221, an angular rate sensor 222, a geomagnetic sensor 223, a GPS sensor 224, an illuminance sensor 225, a temperature/humidity sensor 226, a touch panel 227, an external interface 232, a display unit 241, a display processing unit 242, a video input unit 228, an ear speaker 243, an ambient speaker 244, a sound collecting microphone 229, a call microphone 230, a Bluetooth (registered trademark) communication unit 264, a Near field radio communication (NFC) communication unit 265, a manipulating unit 231, a power supply circuit 207, and a battery 206.

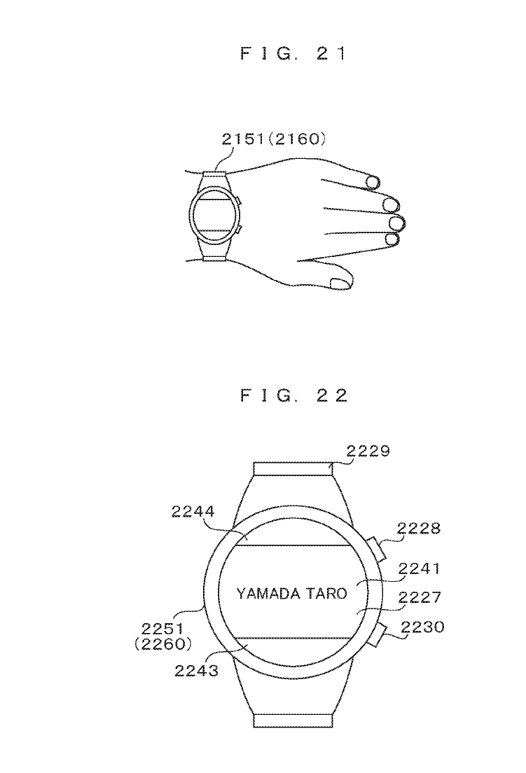

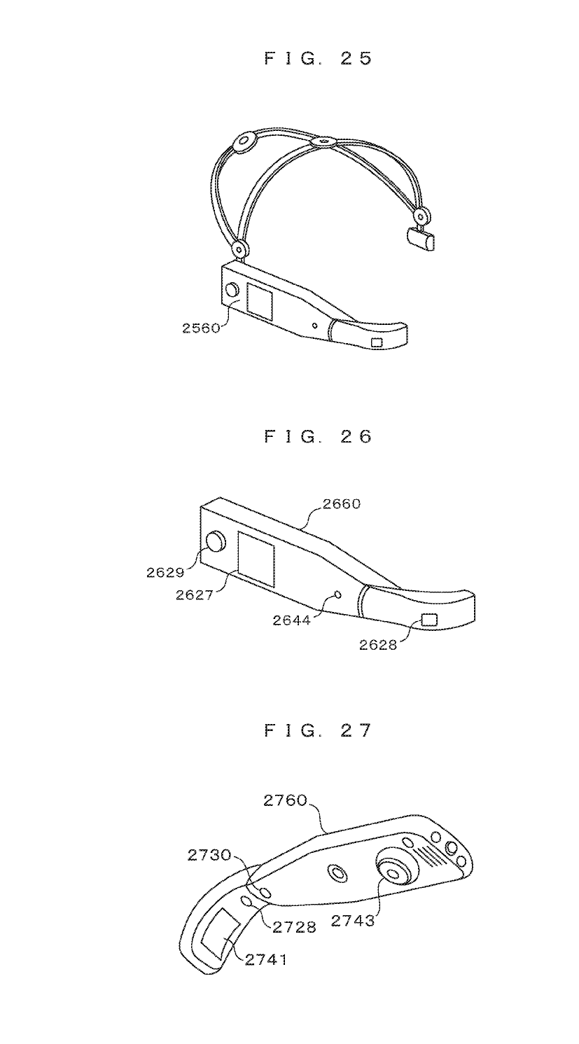

An example of an external diagram of the portable information terminal 151 and the external processing device 152 is illustrated in FIGS. 21 to 30. The details will be described later with reference to representative configuration diagrams of FIG. 21 to FIG. 30, but the portable information terminal 151 may be a wearable computer including a smart watch, a head mounted display, or an ear-ear type information terminal. Further, it may be a portable game machine or other portable digital devices.

In FIG. 2, the information processing unit 201 installed in the portable information terminal 151 is a control unit such as a microprocessor for controlling the entire system of the portable information terminal 151. The system bus 202 is a data communication path for performing transmission and reception of data between the information processing unit 201 and each unit in the portable information terminal 151. The ROM 203 is a memory that stores a program for a basic operation of the portable information terminal 151, and for example, a rewritable ROM such as an electrically erasable programmable ROM (EEPROM) or a flash ROM is used. It is possible to upgrade the version of the basic operation program and expand the function by upgrading the program stored in the ROM 203. The ROM 203 is not an independent configuration as illustrated in FIG. 2, but a partial storage region in the storage unit 205 may be used. The RAM 204 functions as a work region when the basic operation program or each application is executed. Further, the ROM 203 and the RAM 204 may be integrated with the information processing unit 201.

The storage unit 205 stores each operation setting value of the portable information terminal 151, individual information of a user of the portable information terminal 151 or a person who is known by the user (the user or person's own history information since birth, individual information of a acquaintance concerned in the past, a schedule, or the like), and the like. The battery 206 supplies electric power to each circuit in the portable information terminal 151 via the power supply circuit 207.

Here, the external processing device 152 downloads a new application from the application server 156 illustrated in FIG. 1 via the public network 157 and a wireless communication access point 159. The portable information terminal 151 can expand its function by downloading the information as a new application via the Bluetooth communication unit 264 or the NFC communication unit 265. At this time, the downloaded application is stored in the storage unit 205. The application stored in the storage unit 205 is developed and executed on the RAM 204 at the time of use, so that various functions can be implemented.

Even when the portable information terminal 151 is powered off, it is necessary for the storage unit 205 to hold the stored information. Therefore, for example, a flash ROM, a solid state drive (SSD), a hard disc drive (HDD), and the like are used.

The heart rate sensor 220, the acceleration sensor 221, the angular rate sensor 222, the geomagnetic sensor 223, the GPS sensor 224, the illuminance sensor 225, the temperature/humidity sensor 226, or the like detects a state of the portable information terminal 151. With these sensors, it is possible to detect a motion, an inclination, a position, a direction, and the like of the portable information terminal 151. The illuminance sensor 225 detects brightness around the portable information terminal 151.

The external interface 232 is an interface for extending the functions of the portable information terminal 151, and performs a connection of a universal serial bus (USB) device or a memory card, a connection of a video cable for displaying a video on an external monitor, and the like.

The display unit 241 is, for example, a display device such as a liquid crystal panel and provides the user of the portable information terminal 151 with a video signal processed in the display processing unit 242. The video input unit 228 is a camera. The ear speaker 243 is a voice output which is arranged to be particularly easily heard by the user. The ambient speaker 244 is a voice output which is arranged in a case in which it is held in a form other than an original portable use situation (for example, in a case in which a it is put and held in a bag or the like) or so that it is heard by surrounding people. The call microphone 230 is a microphone arranged to pick up, particularly, the voice of the user, and the sound collecting microphone 229 is a microphone arranged to pick up an ambient voice or the like.

The manipulating unit 231 is an instruction input unit for mainly inputting characters on the basis of a manipulation of the user of the portable information terminal 151 or manipulating an application being executed. The manipulating unit 231 may be implemented by a multi-key in which button switches are arranged or may be implemented by the touch panel 227 arranged to overlap the display unit 241. The manipulating unit 231 may be an input using a video signal from the video input unit 228 or a voice signal from the call microphone 230. These may also be used in combination.

The Bluetooth communication unit 264 and the NFC communication unit 265 performs communication with the external processing device 152 illustrated in FIG. 1 or another portable information terminal 158. For example, a plurality of functions in the portable information terminal 151 are activated using an operation of the user of touching the touch panel 227 which is one of the input sensors in the portable information terminal 151 as a trigger, and an information provision instruction signal is transmitted through the Bluetooth communication unit 264 or the NFC communication unit 265.

Here, the external processing device 152 is owned by the user of the portable information terminal 151 and is in a state in which communication between both devices can be performed through short-distance communication. In other words, firstly, in a case in which both devices communicate with each other through the NFC communication unit 265 which is a communication unit of a shorter range, and in a case in which communicate is unable to be performed, communication between both devices is established through the Bluetooth communication unit 264 capable of performing a wider range of communication. The external processing device 152 will be described later in detail, but at least the Bluetooth communication unit and the NFC communication unit are installed, a situation around the user of the portable information terminal 151, for example, video information and/or voice information is detected through various kinds of sensors, a counterpart person who is trying to talk with or talking with someone is determined, and information of the person is transmitted to the portable information terminal 151 through one of the two communication units.

The portable information terminal 151 receives the information through the communication unit such as the Bluetooth communication unit 264 or the NFC communication unit 265, and outputs the information of the talking partner, for example, through the output unit such as the display unit 241 or the ear speaker 243 and conveys the information to the user.

Further, instead of communication with the external processing device 152, communication is established between the communication unit of another portable information terminal 158 owned by the talking partner and the portable information terminal 151 of the user, the portable information terminal 151 inquires about person information of the talking partner, and another portable information terminal 158 provides the person information, and thus similarly to the above-described example, the user of the portable information terminal 151 can acquire the information of the talking partner who owns another portable information terminal 158 and conveys the information to the user as described above.

Here, the operation of the touch panel 227 has been described as the operation of the input sensor in the portable information terminal 151, but the present invention is not limited to this example, and for example, it can be implemented even when the user inputs a gesture, a motion of an eye or a lip, or a voice by using the video input unit 228 or the call microphone 230.

The information from the heart rate sensor 220, the acceleration sensor 221, the angular rate sensor 222, the geomagnetic sensor 223, the GPS sensor 224, the illuminance sensor 225, and the temperature/humidity sensor 226 is used as information for determining a situation in which the user is currently placed. For example, it is possible to decrease the power consumption of the portable information terminal 151 and keep the battery 206 longer by increasing sensitivity of the input sensor in accordance with a change in a heart rate of the user or a change in a motion (acceleration or an angular velocity), increasing detection sensitivity or accuracy of the input sensor (particularly, the video input unit 228 and the call microphone 230) (for example, by decreasing a detection cycle) similarly even in a case in which a place in which the user is currently located is determined to be a place in which a large number of people are gathered, a place in which there is a meeting with a person, or the like through geomagnetism or a GPS, and decreasing the sensitivity of the input sensor when the user is considered to be unlikely to meet another person due to ambient brightness or a change in temperature and humidity.

Next, the external processing device 152 will be described in detail with reference to FIG. 3. In FIG. 3, components having the same numbers as last two digits of the components in FIG. 2 have substantially the same configuration/function as those in FIG. 2. In FIG. 3, the external processing device 152 includes an information processing unit 301, a system bus 302, a ROM 303, a RAM 304, a storage unit 305, a video storage unit 310 that records video information including face authentication information 311 and video extraction information 312 obtained by extracting a plurality of facial features, a voice storage unit 313 that records voice information including voice authentication information 314 and voice extraction information 315 obtained by extracting features of a plurality of voices, a GPS sensor 324, a touch panel 327, an external interface 332, a display unit 341, a display processing unit 342, a video input unit 328, an ear speaker 343, an ambient speaker 344, a sound collecting microphone 329, a call microphone 330, a telephone network communication unit 361, a local region network (LAN) communication unit 362, a WiFi (registered trademark) communication unit 363, a Bluetooth communication unit 364, an NFC communication unit 365, an e-mail processing unit 308, a manipulating unit 331, a power supply circuit 307, and a battery 306.

The external processing device 152 may be a mobile phone, a smart phone, a personal digital assistants (PDA), a handy type personal computer (PC), or a tablet PC. Further, the external processing device 152 may be a portable game machine or other portable digital devices.

As described above, the external processing device 152 performs communication with the Bluetooth communication unit 264 or the NFC communication unit 265 of the portable information terminal 151 through the Bluetooth communication unit 364 or the NFC communication unit 365, records and/or reads the video information and/or the voice information from the video input unit 328 and/or the sound collecting microphone 329 serving as the voice input unit in the external processing device 152 to or from the video storage unit 310 and/or the voice storage unit 313 in accordance with an instruction signal from the portable information terminal 151, analyzes captured image information of a person having a facture of a counterpart whom the user of the external processing device 152 is meeting and voice information including a voice of the counterpart through the information processing unit 301, extracts feature information, compares the feature information with the individual information of the person which is known to the user and stored in the storage unit 305, alters the information of the person in a case in which there is no similar person, stores the altered information in the storage unit 305, and updates and accumulates (records) information related to the person in the storage unit 305 in a case in which it is determined that there is a similar person. Further, the information is provided to the storage unit 205 in the portable information terminal 151 via the Bluetooth communication unit 264 or the NFC communication unit 265 of the portable information terminal 151 through the Bluetooth communication unit 364 or the NFC communication unit 365. The provided information is displayed on the display unit 241 as a video via the display processing unit 242 in the portable information terminal 151. Alternatively, the provided information is output from the ear speaker 243 in the portable information terminal 151 as the voice information.

Here, the video storage unit 310 extracts a feature of the video of the talking partner from the image information input from the video input unit 328 and stores the extracted feature in the video extraction information 312. On the other hand, person authentication information of already stored individual information is sequentially copied from the storage unit 305 to the video extraction information 312, similarity between both pieces of information is determined, a result is stored in the face authentication information 311, and person authentication of whether or not a similar person is an already stored person is performed. Similarly, the voice storage unit 313 extracts a feature of the voice of the talking partner from the voice information input from the sound collecting microphone 329 and stores the extracted feature in the voice extraction information 315. On the other hand, person authentication information of already stored individual information is sequentially copied from the storage unit 305 to the voice extraction information 315, similarity between both pieces of information is determined, a result is stored in the voice authentication information 314, and person authentication of whether or not a similar person is an already stored person is performed. The person authentication may be performed using only one of the video authentication and the voice authentication or may be performed or using both of the video authentication and the voice authentication. Particularly, a usage suitable for the video or the voice is considered depending on an arrangement of the video input unit 328 or the sound collecting microphone 329 or how the main body of the external processing device 152 is worn on the user.

The telephone network communication unit 361 performs communication with the mobile telephone communication e-mail server 154 via the base station 153 of the mobile telephone communication network. The LAN communication unit 362 or the Wi-Fi communication unit 363 performs communication with the wireless communicator access point 159 of the public network 157 or the like.

Using the communication, the e-mail processing unit 308 exchanges e-mail information with the e-mail server 155 that performs e-mail generation, e-mail analysis, and the like. In FIG. 3, the e-mail processing unit 308 is described as an independent configuration, but the same function may be implemented by the information processing unit 301 using the RAM 304 as a work region. For example, a person whom the user will talk with next can be estimated from information held in the e-mail processing unit 308.

Further, the application server 156 may perform some processes of the operation of the information processing unit 301 using the above-described communication network. In particular, the application server 156 may have a functional process of performing a process of extracting the feature from a large amount of individual information or the video information from the video input unit 328 and/or the voice information from the sound collecting microphone 329, a process of comparing both pieces of information and specifying a similar person, or the like. Accordingly, the processing load of the information processing unit 301 can be reduced.

Further, it is possible to collect information from various kinds of information sources in which the information related to the already stored person is open to the public via the public network 157 and update the information of the storage unit 305. For example, if a title in a company to which the person belongs or presentation information at an academic conference or the like is updated, there is an advantage that it is possible to hear detailed information about them at the next meeting.

In the present embodiment, communication is established by the Bluetooth communication unit 264 or the NFC communication unit 265, but the present invention is not limited to the above example as long as a short distance communication device is used. For example, even when near field communication such as IrDA (infrared) communication or ultra wide band radio (UWB) communication is used, the effect of the present invention is not impaired.

As described above, the present embodiment provides a portable information terminal including an input sensor that detects a change in surroundings, a communication unit that performs transmission and reception of information with an external processing device, an output unit that outputs information, and a control unit that detects a predetermined situation from a change in an input signal change from the input sensor, transmits an instruction signal to the external processing device via the communication unit, receives information of a person corresponding to the instruction signal from the external processing device via the communication unit, and outputs the information of the person via the output unit.

Further, provided is an information processing method of a portable information terminal including an input step of detecting a change in surroundings, a transmission step of detecting a predetermined situation from a change in an input signal in the input step and transmitting an instruction signal to an external processing device, a reception step of receiving information of a person corresponding to the instruction signal from the external processing device, and an output step of outputting the information of the person obtained in the reception step.

Accordingly, it is possible to provide a portable information terminal including a function of promptly providing information of a talking partner and a method thereof.

### Second Embodiment

In the present embodiment, a portable information terminal 460 in which the portable information terminal 151 and the external processing device 152 of the first embodiment are integrated will be described.

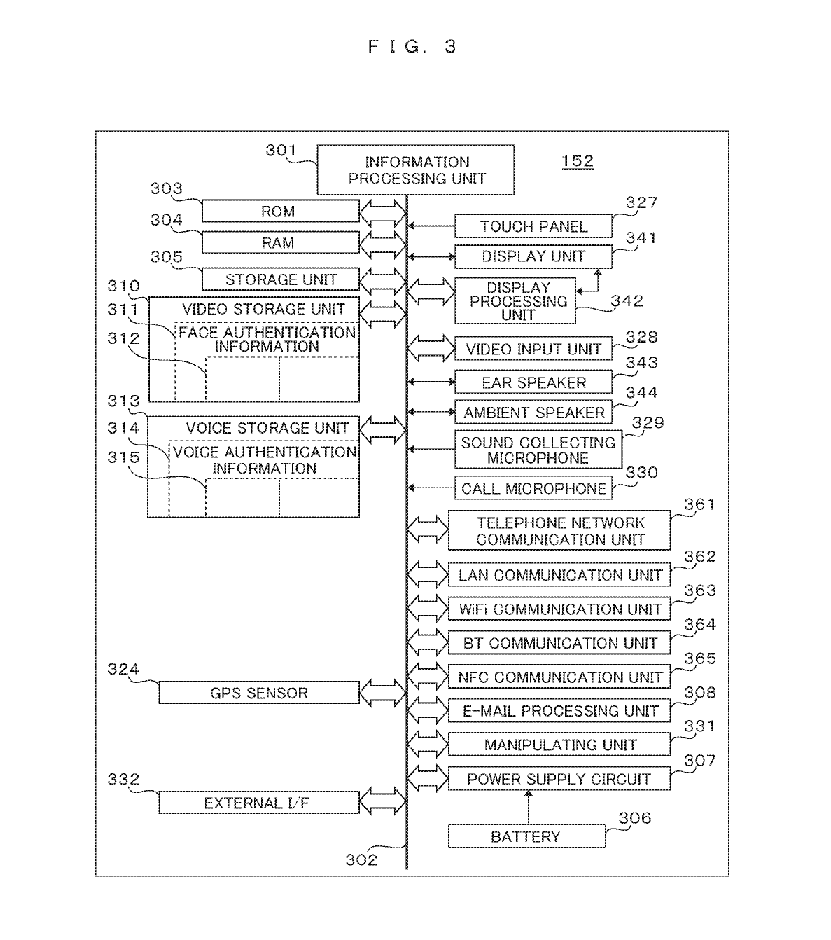

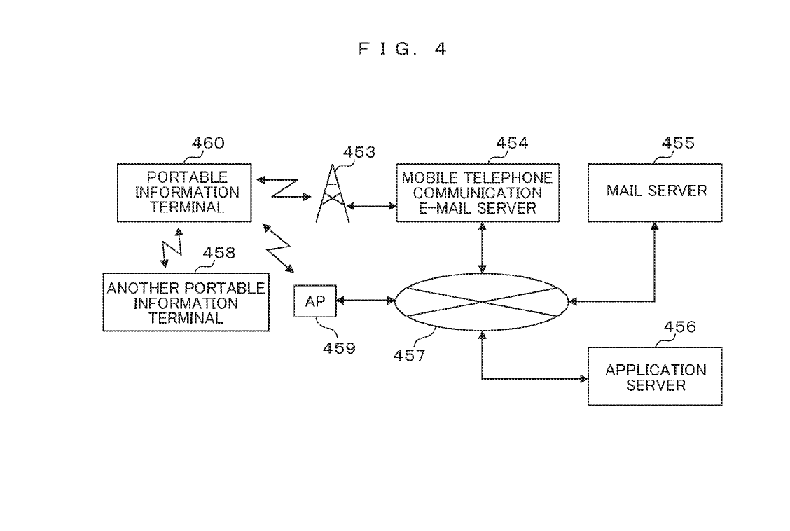

FIG. 4 is an example of a communication system including the portable information terminal 460 of the present embodiment, and the communication system includes a base station 453 of a mobile telephone communication network, a mobile telephone communication e-mail server 454, an internet e-mail server 455, an application server 456, a public network 457, a portable information terminal 458, and a wireless communicator access point 459.

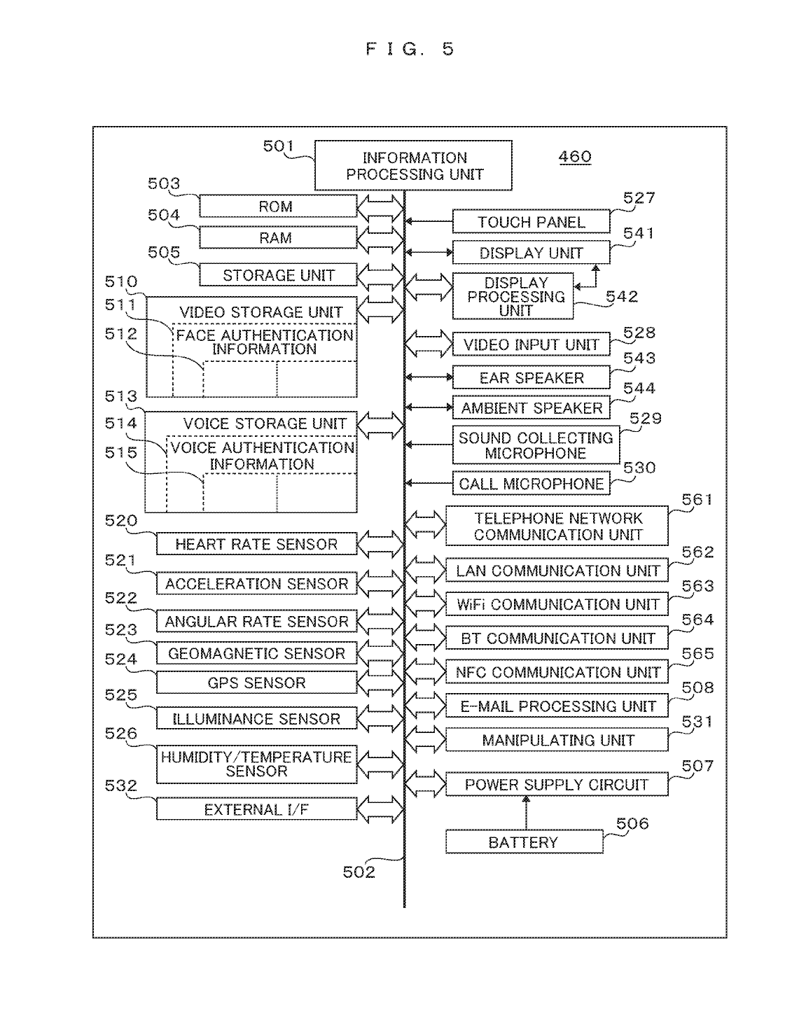

FIG. 5 is a block diagram of the portable information terminal 460 in the communication system of FIG. 1n FIG. 5, the portable information terminal 460 includes an information processing unit 501, a system bus 502, a ROM 503, a RAM 504, a storage unit 505, a video storage unit 510 that records video information including face authentication information 511 and video extraction information 512 obtained by extracting a plurality of facial features, a voice storage unit 513 that records voice information including voice authentication information 514 and voice extraction information 515 obtained by extracting features of a plurality of voices, a heart rate sensor 520, an acceleration sensor 521, an angular rate sensor 522, a geomagnetic sensor 523, a GPS sensor 524, an illuminance sensor 525, a temperature sensor 526, a touch panel 527, an external interface 532, a display unit 541, a display processing unit 542, a video input unit 528, an ear speaker 543, an ambient speaker 544, a sound collecting microphone 529, a call microphone 530, a telephone network communication unit 561, a LAN communication unit 562, a WiFi communication unit 563, a Bluetooth communication unit 564, an NFC communication unit 565, an e-mail processing unit 508, a manipulating unit 531, a power supply circuit 507, and a battery 506.

In FIGS. 4 and 5, components having the same numbers as last two digits of the components in FIGS. 1 to 3 have substantially the same configuration/function as those in FIGS. 1 to 3. An example of an external diagram of the portable information terminal 460 is illustrated in FIGS. 21 to 30. The details will be described later with reference to representative configuration diagrams of FIG. 21 to FIG. 30, but the portable information terminal 460 may be a wearable computer including a smart watch, a head mounted display, or an ear-ear type information terminal. Further, it may be a portable game machine or other portable digital devices.

As illustrated in FIG. 5, the respective components installed in the portable information terminal 460 are the components installed in the portable information terminal 151 and the external processing device 152 described above and constitute a device in which the respective devices are integrated. In FIG. 5, the information processing unit 501 performs the process performed by the information processing unit 201 and the process performed by the information processing unit 301. The following description will proceed with a different process caused by the integration.

Here, as illustrated in FIG. 4, the portable information terminal 460 can expand the function by directly downloading a new application from the application server 456 via the public network 457 and the wireless communication access point 459.

In FIG. 5, a situation around the user of the portable information terminal 460, for example, the video information and/or the voice information are detected by the video input unit 528 and/or the sound collecting microphone 529 serving as the detecting sensors, and it is determined whether or not there is a person of a counterpart who is trying to talk with or talking with someone. In a case in which such a person is detected, the information processing unit 501 extracts the feature of the person from the video information and/or the voice information obtained by the video input unit 528 and/or the sound collecting microphone 529. Here, it is determined whether or not a similar person is an already stored person by sequentially comparing the person extracted from the detecting sensor with the person authentication information of an already stored individual information from the storage unit 505 using the video storage unit 510 and the voice storage unit 513. If it is determined that the person information of the person whom the user met in the past is not stored in the storage unit 505, the information is newly stored in the storage unit 505. In a case in which there is a similar person, new information obtained in the current meeting is updated, and the information is stored in the storage unit 505. Then, the information of the talking partner is output and conveyed to the user through the display unit 541 and/or the ear speaker 543.

The portable information terminal 460 is normally in a function standby state in a case in which it is powered on. The power consumption in the function standby state can be reduced by checking a terminal manipulation of the user on the touch panel which is one of the input sensors or the like in the function standby state, activating a plurality of functions in the portable information terminal 460 and causing the function of the present invention to enter an active state.

In other words, the portable information terminal 460 uses the video storage unit 510 and/or the voice storage unit 513 for the video information and/or the voice information from the video input unit 528 and/or the sound collecting microphone 529 in accordance with, for example, the input instruction signal from the touch panel 527, analyzes the captured image information of the person including the face of the counterpart whom the user of the portable information terminal 460 is meeting and/or the voice information including the voice of the person, extracts the feature information, compares the extracted feature information with the individual information of the person stored in the storage unit 505, alters the information of the person in a case in which there is no similar person, stores the altered information in the storage unit 305, and updates and accumulates (records) information related to the person in the storage unit 305 in a case in which it is determined that there is a similar person. Further, the information is displayed on the display unit 541 as a video through the display processing unit 542 in the portable information terminal 460. Alternatively, the information is output from the ear speaker 543 in the portable information terminal 551 as the voice information.

The communication unit of the portable information terminal 460 of the user establishes communication with the communication unit of another portable information terminal 458 owned by the talking partner and is provided with the person information of the talking partner from another portable information terminal 458, and thus similarly to the above-described example, the user of the portable information terminal 460 acquires the information of the talking partner who owns another portable information terminal 458, determines whether or not there is a person similar to the information of the person of the storage unit 505 in which the acquired information is already stored, newly accumulates the information of the person in the storage unit 505 in a case in which there is no similar person, updates the information of the person in a case in which there is a similar person, and accumulates the updated information of the person in the storage unit 505. In any case, the information of the person, that is, the information of the talking partner, is output and conveyed to the user by the display unit 541 and/or the ear speaker 543.

Further, when the person information of the talking partner is received from another portable information terminal 458, the video information and/or the voice information from the video input unit 528 and/or the sound collecting microphone 529 are input, the person of the counterpart whom the user is meeting is compared with the individual information of the person stored in the storage unit 505, it is accumulated in the storage unit 505 in a case in which it is determined that there is a similar person, and the information of the talking partner is output and conveyed to the user through the display unit 541 and the ear speaker 543. Accordingly, it is possible to prevent an operation of acquiring the information from a plurality of other portable information terminals 458 and performing an erroneous output when there are a plurality of persons therearound except for the taking partner.

Further, as a countermeasure for improving performance of the prevention method, the voice information obtained by detecting the voice information of the speech of the talking partner by the call microphone installed in the portable information terminal 458 is transmitted from another portable information terminal 458 owned by the talking counterpart to the portable information terminal 460 of the user substantially in real time together with the individual information. Upon receiving the information, the portable information terminal 460 detects the motion and/or the voice information of the lip of the talking partner using the video input unit 528 and/or the sound collecting microphone 529, checks similarity with the information received via communication, and determines whether or not the received individual information is the information of the talking partner. According to this method, in a case in which there are a plurality of persons, although the personal information is received from a plurality of other portable information terminals substantially at the same time, it is possible to determine the owner of each of the other portable information terminals. In particular, even when the person is a new person and not registered in the storage unit 505, if this method is used, it is possible to prevent the operation of acquiring the information from a plurality of other portable information terminals 458 and performing an erroneous output when there are a plurality of persons therearound except for the taking partner.

Here, the operation of the touch panel 527 has been described as the operation of the input sensor in the portable information terminal 460, but the present invention is not limited to this example, it can be implemented even when the user inputs a gesture, a motion of an eye or a lip, or a voice by using the video input unit 528 or the call microphone 530. Here, since it is necessary for the video input unit 528 to image the user while imaging the talking partner, a sufficient viewing angle is required, but two cameras may be installed for the user and the talking partner depending on a configuration.

The information from the heart rate sensor 520, the acceleration sensor 521, the angular rate sensor 522, the geomagnetic sensor 523, the GPS sensor 524, the illuminance sensor 525, and the temperature sensor 526 is used as information for determining a situation in which the user is currently placed. Further, the components not described with reference to FIG. 5 perform similar operations as those described with reference to FIGS. 2 and 3.

The telephone network communication unit 561 performs communication with the base station 453 of the mobile telephone communication network. The LAN communication unit 562 or the Wi-Fi communication unit 563 performs communication with the wireless communicator access point 559 of the public network 557 or the like.

Using the communication, the e-mail processing unit 508 exchanges e-mail information with the e-mail server 455 that performs e-mail generation, e-mail analysis, and the like. In FIG. 5, the e-mail processing unit 508 is described as an independent configuration, but the same function may be implemented by the information processing unit 501 using the RAM 504 as a work region. For example, a person whom the user will talk with next can be estimated from information held in the e-mail processing unit 508.

Further, the application server 456 may perform some processes of the operation of the information processing unit 501 using the above-described communication network. In particular, the application server 556 may have a functional process of performing a process of extracting the feature from a large amount of individual information or the video information from the video input unit 528 and/or the voice information from the sound collecting microphone 529, a process of comparing both pieces of information and specifying a similar person, or the like. Accordingly, the processing load of the information processing unit 501 can be reduced.

### Third Embodiment

In the present embodiment, a person determination method using the video information performed by the information processing unit 301 of the external processing device 152 in the first embodiment or the information processing unit 501 of the portable information terminal 460 in the second embodiment will be described.

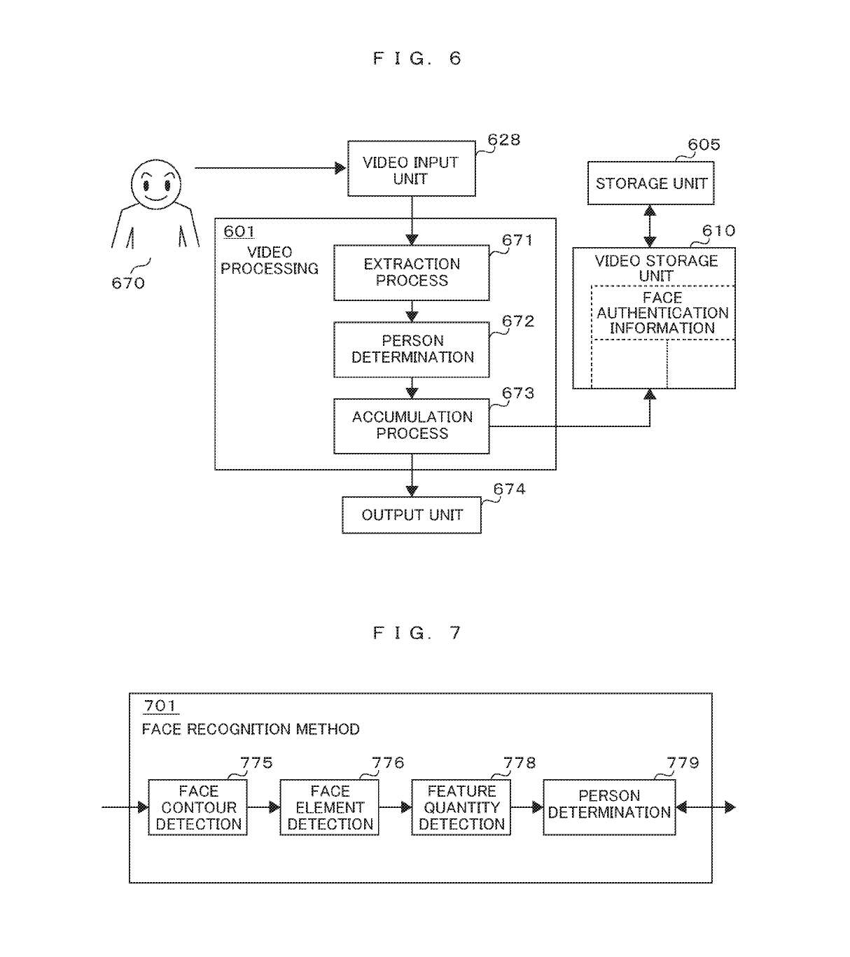

An explanatory function diagram of the information processing unit in the present embodiment is illustrated in FIG. 6. In FIG. 6, components having the same numbers as last two digits of the components in FIGS. 1 to 5 have substantially the same configuration/function as those in FIGS. 1 to 5. As illustrated in FIG. 6, the person determination method is performed by a video input unit 628, a video processing unit 601 having a video processing function including an extraction process 671, a person determination 672, and an accumulation process 673, a storage unit 605, a video storage unit 610, and an output unit 674.

As a specific example of the extraction process 671 and the person determination 672, a face recognition method will be described with reference to FIG. 7. The extraction process 671 and the person determination 672 of the face recognition method are performed by an information processing unit 701 including a face contour detection 775 that detects a contour of a face from frame data of a person 670 imaged by the video input unit 628, a face element detection 776 that detects face elements such as eyes, nose, and a mouth in the contour of the face detected by the face contour detection 775, a feature quantity detection 778 that calculates a feature quantity on the basis of the face elements detected by the face element detection 776, and a person determination 779 that determines whether or not they are the same person by comparing a feature quantity detected in a certain frame with a feature quantity detected in another frame.

The video processing unit 601 reads program data of the face recognition method stored in the ROMs 203, 303, and 503 and sequentially executes the program data. First, the video processing unit 601 detects the contour of the face in the frame by the face contour detection 775. If the contour of the face is unable to be detected in the frame, the frame is discarded as noise. Then, the video processing unit 601 detects the face elements such as eyes, nose, mouth, and the like in the contour of the face by the face element detection 776. Then, the video processing unit 601 detects the feature quantities such as a size, a position, and a positional relation between elements of each element by the feature quantity detection 778 and stores the feature quantities in the video storage unit 610 for each frame. In a case in which it is requested to determine whether or not a person shown in a certain frame and a person moved to another frame are the same person, the video processing unit 601 sequentially reads the stored feature quantities for each frame and calculates a difference with a feature quantity of a frame to be determined. In a case in which the difference is equal to or less than a threshold value, the person determination 779 determines that the persons are likely to be the same person.

The person determination 779 reads the information from the storage unit 605 in which the previous person information of the talking partner is recorded out to the video storage unit 610, calculates a difference with the feature amount similarly to the calculation of the difference between the frames, and determines that they are likely to be the same when the difference is equal to or less than a threshold value.

As described above, if the person determination 779 sequentially reads the person information of the person met in the past from the storage unit 605 and determines that there is no similar person, the accumulation process 673 newly stores the information in the storage unit 605 via the video storage unit 610. In a case in which there is a matched person, new information obtained by the current meeting is updated and stored in the storage unit 605 via the video storage unit 610.

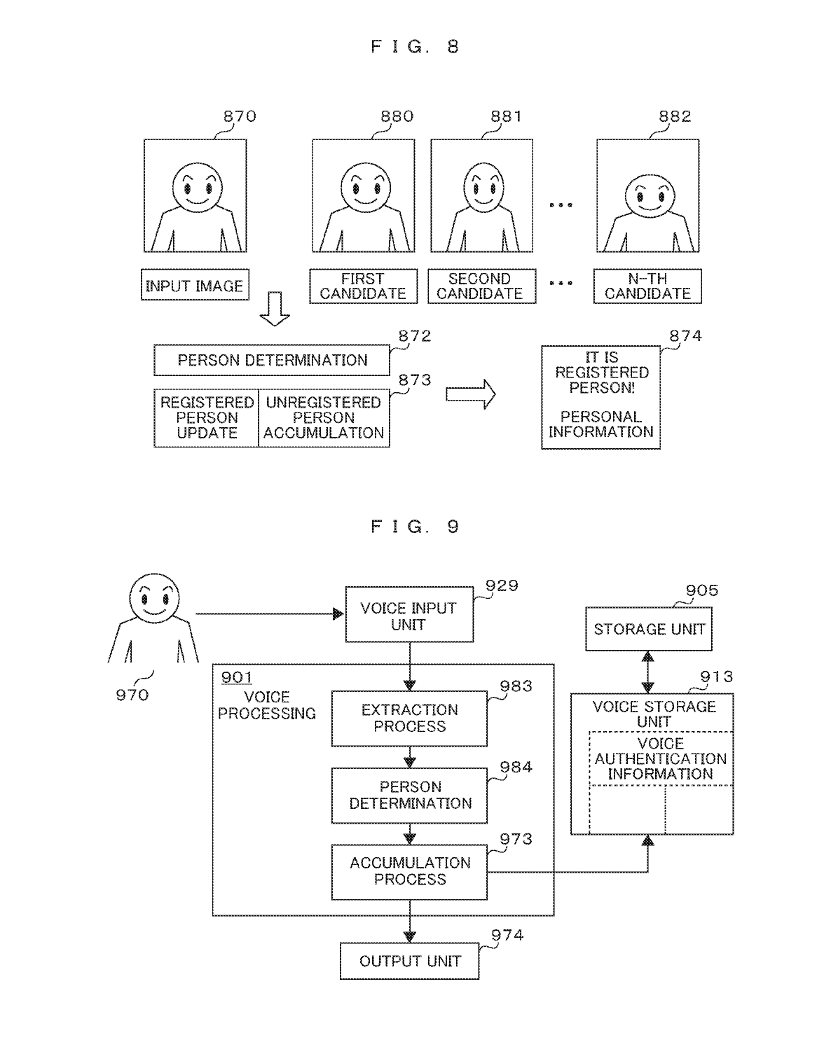

Further, an operation of the person determination 779 will be described using a specific example by the information processing unit 801 illustrated in FIG. 8. The functions person determination 779 include a person determination 872 that determines whether or not both pieces information, that is, image information 870 of the person 670 currently imaged by the video input unit 228, 328, and 528 and a plurality of pieces of image information 880 to 883 which are sequentially or collectively obtained in the video storage unit 610 that reads the information from the storage unit 605 and temporarily stores the information are similar, an accumulation process 873 that newly accumulates the information of the person in a case in which the person determination 872 determines that there is no similar person and updates and accumulates the information of the person in a case in which there is a similar person, and an output 874 that outputs the information of the person in a case in which there is a similar person. The person determination 872 determines whether or not the image information 870 and the image information 880 to 882 are similar, and depending on the result, for example, if similar information is the image information 880, the information is output to the output 874, and the new information is updated and accumulated, whereas if there is no similar information, it is accumulated as a new person. Here, in a case in which there is no similar information, output information indicating that there was no meeting in the past is output, or information of a range understood from information obtained from the captured image is output. Further, the image information 870 and 880 to 882 are illustrated as the image information, but any information can be used as long as the information indicates the feature of person.

### Fourth Embodiment

In the present embodiment, a person determination method using the voice information performed by the information processing unit 301 of the external processing device 152 in the first embodiment or the information processing unit 501 of the portable information terminal 460 in the second embodiment will be described.

An explanatory function diagram of the information processing unit in the present embodiment is illustrated in FIG. 9. In FIG. 9, components having the same numbers as last two digits of the components in FIGS. 1 to 8 have substantially the same configuration/function as those in FIGS. 1 to 8. As illustrated in FIG. 9, the person determination method is performed by a voice input unit 929, a voice processing unit 901 having a video processing function including an extraction process 983, a person determination 984, and an accumulation process 973, a storage unit 905, a voice storage unit 913, and an output unit 974.

As a specific example of the extraction process 983 and the person determination 984, a voice recognition method will be described below. The extraction process 983 and the person determination 984 of the voice recognition method extract some features from voice data of a person 970 (speaker) collected by the voice input unit 929 and construct a “voice print,” a “template,” or a “model.” In authentication or identification, the voice processing unit 901 reads program data of the voice recognition method stored in the ROMs 303 and 503, and sequentially executes the program data. First, the voice processing unit 901 detects the voice of the person 970 (speaker) who speaks face to face from the voice collected by the voice input unit 929 by the extraction process 983. If the voice of the person 970 (speaker) is unable to be detected, the information is discarded as noise. Then, the voice processing unit 901 extracts some features from the posted voice. For example, “voice print” information is extracted by analysis of a sound spectrogram or the like. In the person determination 984, the information is read out from the storage unit 905 in which the previous person information of the past talking partner is recorded to the voice storage unit 913, and a difference in the feature amount with the output information of the extraction process 983 is calculated, and in a case in which the difference is equal to or less than a threshold value, it is determined they are likely to be the same person.

As described above, in a case in which the person determination 984 sequentially reads the person information met in the past from the storage unit 905 and determines that there is no matched person, the accumulation process 973 newly stores the information in the storage unit 905 via the voice storage unit 913. In a case in which there is a matched person, new information obtained in the current meeting is updated, and the information is stored in the storage unit 905 via the voice storage unit 913.

Further, the person determination 984 functions to determine whether or not the information of the person 970 (speaker) being collected by the current voice input unit 929 is similar to a plurality of pieces of person information which are sequentially or collectively obtained in the voice storage unit 913 that reads the information from the storage unit 905 and temporarily stores the information. In a case in which the person determination 984 determines that there is no similar person, the information of the person is newly accumulated, and in a case in which there is a similar person, the information of the person is updated. Further, in a case in which there is a similar person, it is constituted by the output unit 974 that outputs the information of the person. Here, the information of the person is not limited to the “voice print” according to the analysis of the sound spectrogram, but any information can be used as long as the information indicates the feature of the voice of the person.

Further, since the accuracy of the person recognition by the voice is sometimes low, it is desirable to use a process of increasing the accuracy using the video recognition method of the third embodiment in combination.

An application example of performing recognition of content of a conversation in addition to person authentication by the “voice print” will be described with reference to FIG. 10 as an application example of the voice recognition method. A processing method of the information processing units 201, 301, and 501 using the sound collecting microphones 229, 329, and 529 and the call microphones 230, 330, and 530 which are the input sensors and the detecting sensors is illustrated. An information processing unit 1001 includes a voice interval detection 1085, a voice recognition 1086, and a correction 1087.

In FIG. 10, only a textable voice language included in an input voice is set as a target, a voice interval including the voice language is detected from the input voice by the voice interval detection 1085, and the corresponding interval is cut out. Then, the cut voice interval is speech-recognized by the voice recognition 1086, and text data of a word string serving as a recognition result is output. Since the recognition result usually includes a recognition error, the error in the recognition result is automatically corrected on the basis of the information in the storage units 305 and 505 which is already accumulated, and a correction result is extracted. A series of procedures is sequentially performed each time the voice interval is cut out, and an output can be performed with a low delay.

FIG. 11 illustrates an example of a manipulation method by voice of the user using the voice recognition illustrated in FIG. 10. A method of processing the voice of the user is performed by an information processing unit 1101 including voice information 1188 and information 1189 in which information corresponding to the voice information 1188 is accumulated. The information 1189 is assumed to be already stored in the storage units 305 and 505. The voice is detected from the call microphone 230, 330, and 530, and when the user selects information which is desired to be obtained preferentially from the inside of the information 1189 related to the talking partner in accordance with the words, the information is displayed on the display units 241, 341, and 541 constituting the output unit, or the voice information is output the ear speakers 243, 343, and 543. Only one of the outputs may be used, or both outputs may be used in combination.

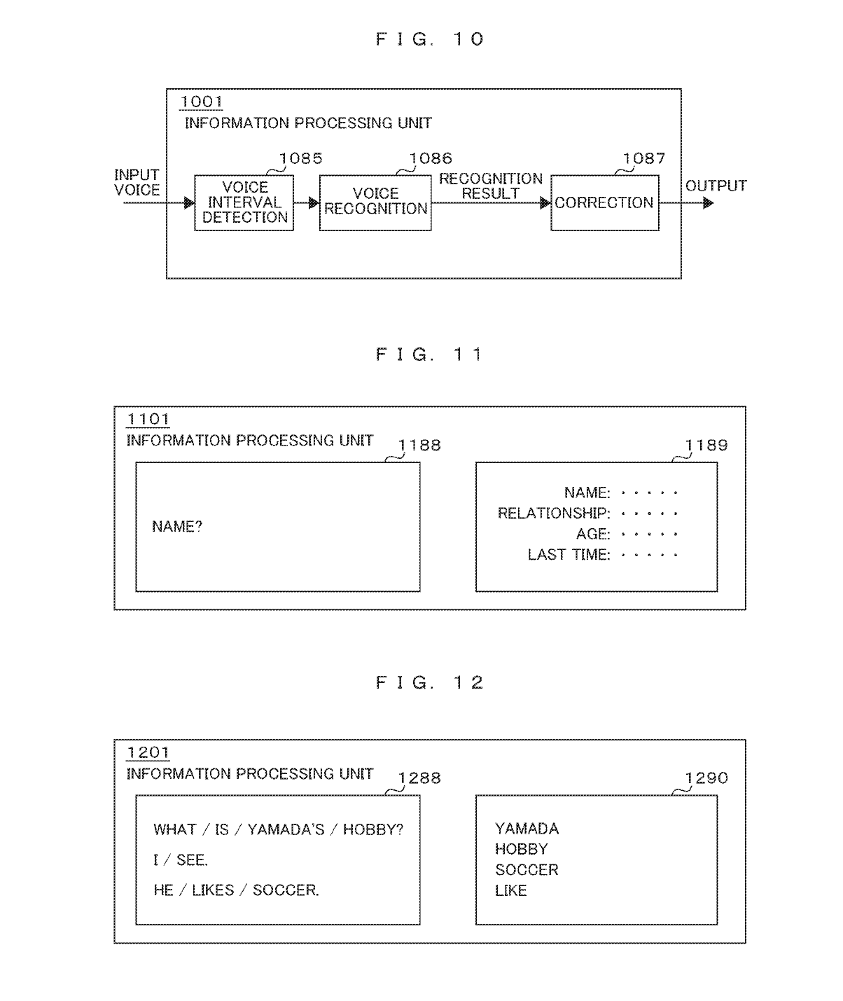

Another example of the method using the voice recognition illustrated in FIG. 10 will be described with reference to FIG. 12. A processing method of the information processing unit 201, 301, and 501 using the sound collecting microphones 229, 329, and 529 and the call microphones 230, 330, and 530 which are the input sensors and the detecting sensors is illustrated. The method of processing the voices of the user and the talking partner is performed by an information processing unit 1201 including voice information 1288 and information 1290 in which necessary conversation content obtained by extracting feature information from the voice information and analyzing the feature information is accumulated. A conversation between the user and the talking partner is input (detected) from the sound collecting microphones 229, 329, and 529 and the call microphones 230, 330, and 530, content of the conversation is analyzed, necessary conversation content is extracted from important words, and the information 1290 is stored in the storage units 205, 305, and 505 as the information of the talking partner.

### Fifth Embodiment

In the present embodiment, an output method to the display processing units 242, 342, and 542, the display units 241, 341, and 541 and the ear speaker 243, 343, and 543 in the portable information terminal 151 or the external processing device 152 in the first embodiment and the portable information terminal 460 in the second embodiment will be described.

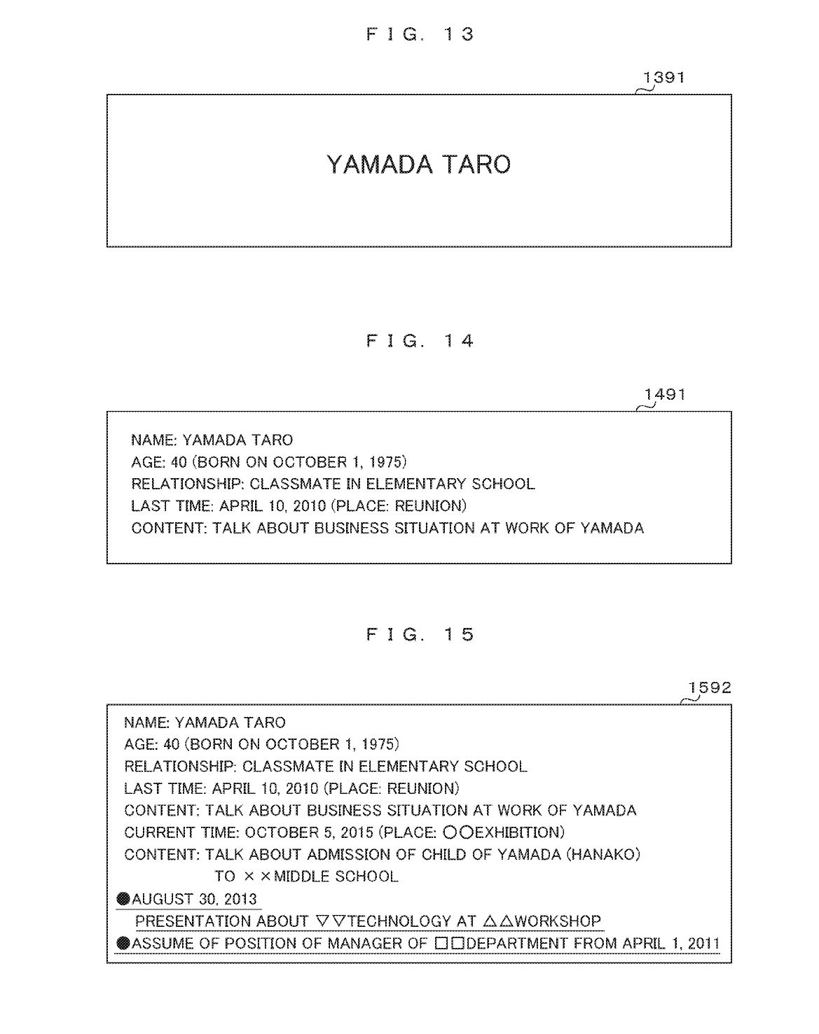

A display screen example in the present embodiment are illustrated in FIGS. 13 to 16. Basically, an output in the present embodiment is output by display and a sound so that information is conveyed to the user through the display unit 241 and 541 and the ear speaker 243 and 543 of the portable information terminal 151 and the portable information terminal 460, but information may be displayed on the display unit 341 and the ear speaker 343 of the external processing device 152.

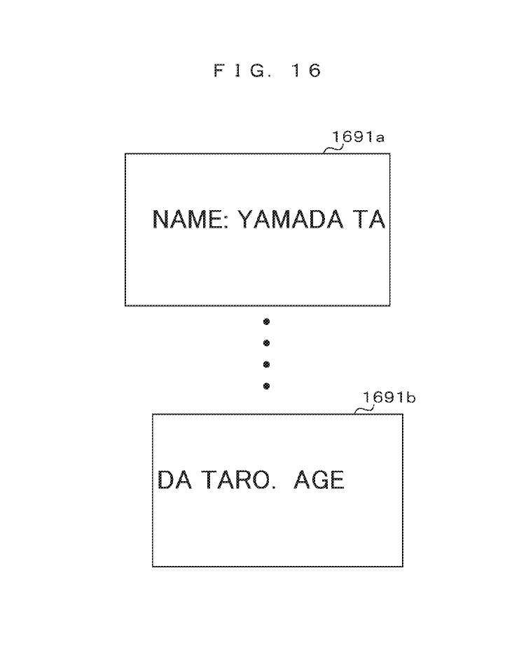

For example, a name of the talking partner is displayed as the display information as illustrated on a display screen 1391 of FIG. 13. In a display screen 1491 of FIG. 14, further detailed information is displayed. For example, a name, an age, a relationship with the user, a date and time at the last meeting, conversation content at the last meeting, and the like are displayed, and thus the user can easily conceive of a new conversation content with talking partner. Further, on a display screen 1592 of FIG. 15, in a case in which the user meets the talking partner for whom the information illustrated in FIG. 14 is already stored, when information is exchanged other portable information terminals 158 and 458 owned by the talking partner and the portable information terminals 151 and 460 owned by the user, control is performed such that only information after the last meeting is exchanged, and thus it is possible to reduce a communication information amount (only underlined information in FIG. 15 is exchanged). Further, when the two portable information terminals are within a predetermined distance or within communicable a distance or when the talking partner is recognized on the basis of input information from the video input unit 228, 328, and 528, the sound collecting microphones 229, 329, and 529, or the like, communication is performed between the two portable information terminals. Further, each portable information terminal can perform a setting of whether or not the individual information of the user of each portable information terminal is disclosed.

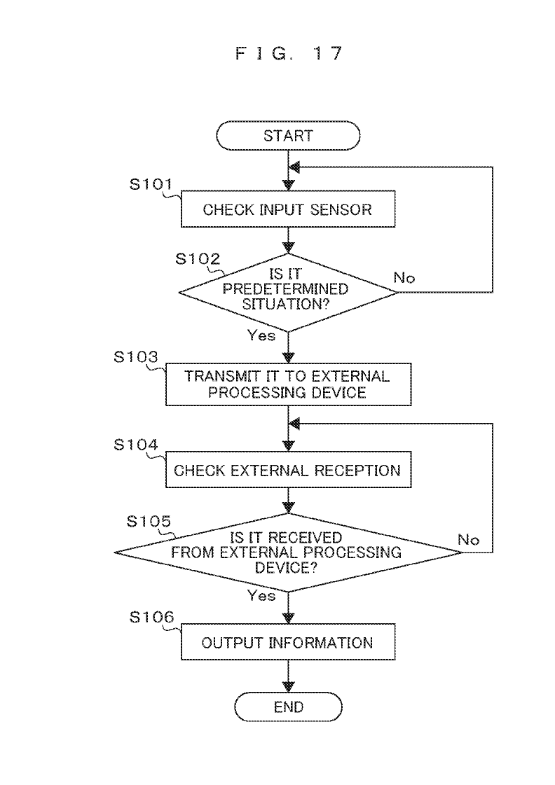

As another display method, as illustrated on display screens 1691a to 1691b in FIG. 16, in a case in which display regions of the display units 241, 341, and 541 are small, the display information can be automatically scrolled and displayed.

Here, although not illustrated, these pieces of information may be output as the voice information from the ear speakers 243, 343, and 543, or the video and the voice may be used together.

Further, as described above, communication is established between the communication unit of another portable information terminal 158 owned by the talking partner and the portable information terminal 151 of the user, the portable information terminal 151 inquires about the person information of the talking partner, and another portable information terminal 158 provides the person information, and thus it is possible acquire the information of the talking partner and convey the information to the user, but similarly, the individual information of the user held in the portable information terminal 151 of the user (for example, held in the storage units 205, 305, and 505) can be supplied to another portable information terminal 158 used by the talking partner. Here, for example, it is possible to automatically change an information level on the basis of a relationship of both parties, for example, by providing only a name to a counterpart who is first met as the individual information, providing related to a business to a counterpart with a close relationship in terms of a business, or providing information of a family to a counterpart with a close relationship such as a family, and it is possible to set them through the manipulating units 231, 331, and 531 manually.

### Sixth Embodiment

In the present embodiment, an operation of the process of the portable information terminal 151 in the first embodiment will be described.

FIG. 17 is a processing flowchart for inquiring about the individual information of the talking counterpart using the terminal manipulation of the portable information terminal 151 in the present embodiment as a trigger.

In FIG. 17, the portable information terminal 151 is normally in a function standby state in a case in which it is powered on. In the function standby state, the portable information terminal 151 checks the terminal manipulation of the user on the touch panel 227 which is one of the input sensors, or the like (S101) and determines a predetermined situation of whether or not there is an input to the touch panel 227 (S102). In a case in which there is no input, the portable information terminal 151 returns to an input standby state again. In a case in which it is checked that there is an input, an inquiry about the individual information of the counterpart who the user is currently trying to meet or meeting is transmitted to the external processing device 152 (S103) is performed using it as a trigger. Thereafter, reception of information of a specific person from the external processing device 152 is checked (S104). Then, it is determined whether or not there is reception from the external processing device 152 (S105). In a case in which there is no reception, it returns to a reception standby state from the external processing device 152 again. In a case in which it is checked that there is reception, the information is output to the output unit (for example, the display unit 241), the information is accumulated in the storage unit 205, and the process ends.

The external processing device 152 is assumed to receive the transmission signal from the portable information terminal 151, detect the captured image information and/or the voice information of the counterpart whom the user is currently trying to meet or meeting from the video input unit 328 and/or the sound collecting microphone 329, compare the feature with the information already stored in the storage unit 305, specify the person, and transmit the individual information of the person to the portable information terminal 151.

Alternatively, the external processing device 152 is assumed to receive the transmission signal from the portable information terminal 151, establish communication with another portable information terminal 158 using the Bluetooth communication unit 364 or the NFC communication unit 365, acquire the individual information of the user stored in another portable information terminal 158, and transmit the individual information of that person to the portable information terminal 151.

Here, in addition to the above-mentioned touch panel, for example, the input sensor may determine a case in which the person meeting the user is detected from the image captured by the video input unit 228 as the predetermined situation or determine a case in which the voice information input from the sound collecting microphone 229 is detected to be larger than a predetermined threshold or a case in which a predetermined word as the predetermined situation.

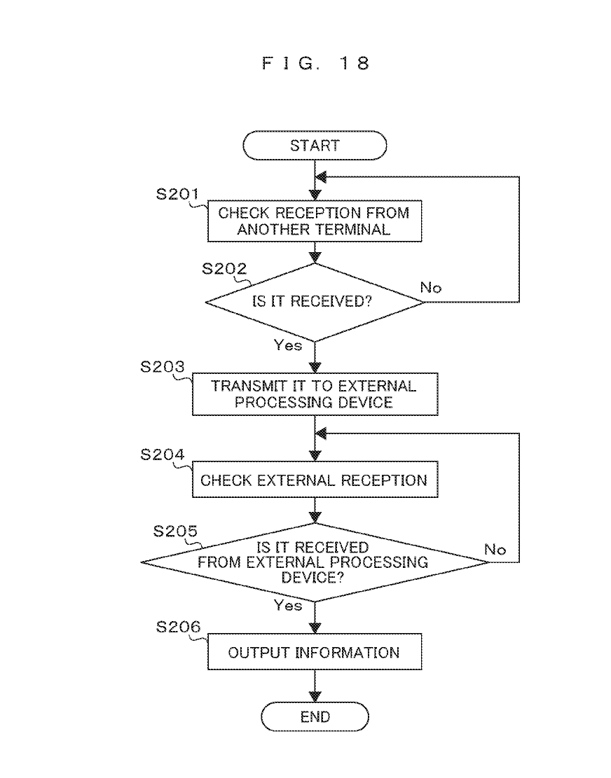

FIG. 18 is a processing flowchart for inquiring about the individual information of the talking counterpart using the approach of another portable information terminal 158 to the portable information terminal 151 in the present embodiment as a trigger.

In FIG. 18, the portable information terminal 151 is normally in a function standby state in a case in which it is powered on. In the function standby state, it is checked that communication from another portable information terminal 158 is received as an input sensor (S201), and a situation of whether or not communication from another portable information terminal 158 is established by the Bluetooth communication unit 264 or the NFC communication unit 265 is determined (S202). In a case in which there is no reception, it returns to the input standby state again. In a case in which it is checked that there is an input, an inquiry about the individual information of the counterpart who the user is currently trying to meet or meeting is transmitted to the external processing device 152 (S203) is performed using it as a trigger. Thereafter, reception of information of a specific person from the external processing device 152 is checked (S204). Then, it is determined whether or not there is reception from the external processing device 152 (S205). In a case in which there is no reception, it returns to a reception standby state from the external processing device 152 again. In a case in which it is checked that there is reception, the information is output to the output unit (for example, the display unit 241), the information is accumulated in the storage unit 205, and the process ends.

In FIGS. 17 and 18, the output unit is not limited to the display unit 241, but, for example, a method of conveying the information to the user through the voice information from the ear speaker 243 may be used. Further, in the accumulation in the storage unit 205, the information is updated in a case in which there is information of the same person already, and the information of the person is newly stored in a case in which there is no same person. Further, it is possible to exchange information of a registered person of the storage unit 205 and the storage unit 305 and share the same information at the time of mutual communication between the portable information terminal 151 and the external processing device 152 of S103 or S104.

### Seventh Embodiment

In the present embodiment, an operation of a process of the portable information terminal 460 in the second embodiment will be described.

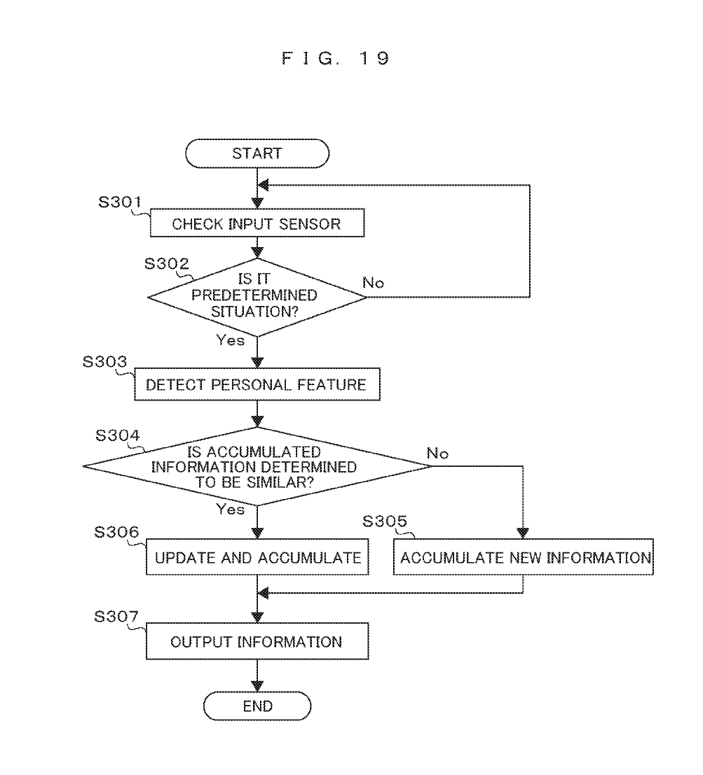

FIG. 19 is a processing flowchart for acquiring the individual information of the talking counterpart using the terminal manipulation of the portable information terminal 460 in the present embodiment as a trigger.

In FIG. 19, the portable information terminal 460 is normally in a function standby state in a case in which it is powered on. In the function standby state, the portable information terminal 460 checks the terminal manipulation of the user on the touch panel 527 which is one of the input sensors, or the like (S301) and determines a predetermined situation of whether or not there is an input to the touch panel 327 (S302). In a case in which there is no input, the portable information terminal 460 returns to an input standby state again. In a case in which it is checked that there is an input, in order to the individual information of the counterpart who the user of the portable information terminal 460 is currently trying to meet or meeting using it as a trigger, the feature of the person meeting with the user is detected on the basis of the image captured by the video input unit 528 and/or the voice collected by the sound collecting microphone 529 (S303). It is determined whether or not there is person information in which the information is similar to the information already stored in the storage unit 505 (S304)

As a result, if there is no similar information, the information of the person is newly stored (S305), and if there is similar information, the already stored information is updated with the information and stored (S306). Thereafter, the information is output to the output unit (for example, the display unit 541) (S307), and the process ends.

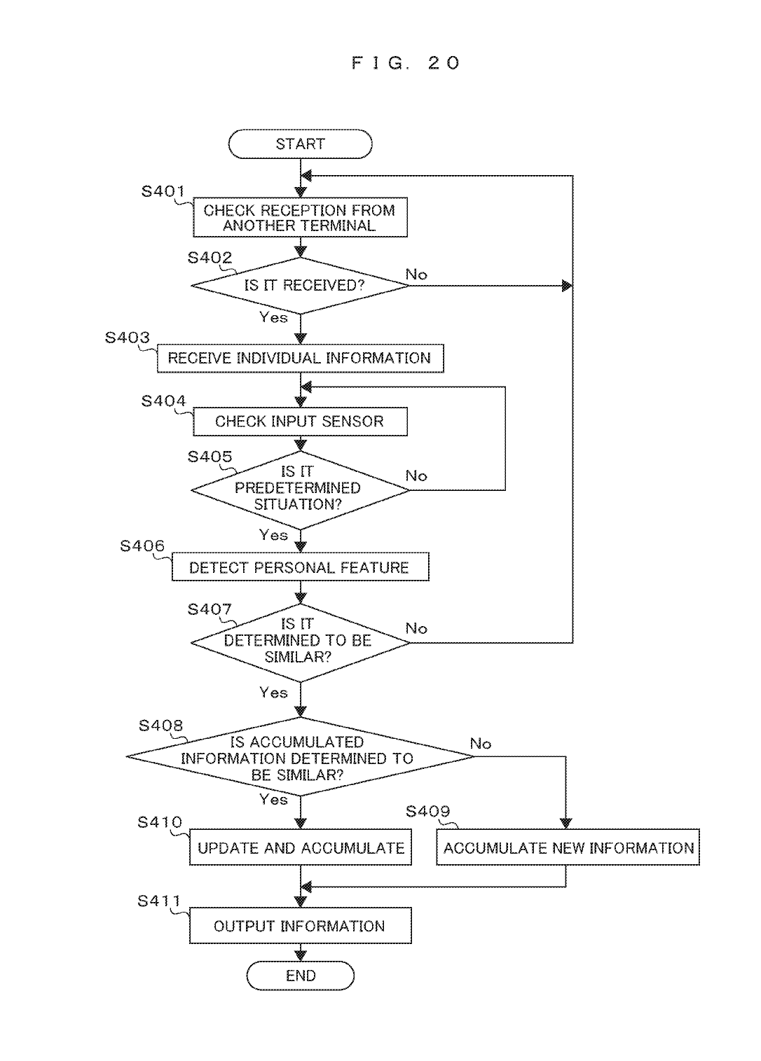

FIG. 20 is a processing flowchart for acquiring the individual information of the talking counterpart using the approach of another portable information terminal 458 to the portable information terminal 460 in the present embodiment as a trigger.

In FIG. 20, the portable information terminal 460 is normally in a function standby state in a case in which it is powered on. In the function standby state, it is checked that communication from another portable information terminal 458 is received as an input sensor (S401), and a situation of whether or not communication from another portable information terminal 458 is established by the Bluetooth communication unit 564 or the NFC communication unit 565 is determined (S402). In a case in which there is no reception, it returns to the input standby state again. In a case in which it is checked that there is reception, the individual information of the user stored in another portable information terminal 458 is acquired (S403). Further, a change in the input situation from the input sensor such as the touch panel 527, the video input unit 528, or the sound collecting microphone 529 is checked (S404), and it is determined whether or not it is a predetermined situation (S405). Here, for example, the predetermined situation may be determined such that a case in which the person meeting with the user is detected from the image captured by the video input unit 528 is determined as the predetermined situation or a case in which the voice information input from the sound collecting microphone 529 is detected to be larger than a predetermined threshold or a case in which a predetermined word is determined as the predetermined situation. Then, in a case in which it is not the predetermined situation, the input situation is continuously monitored, and in a case in which it is determined to be the predetermined situation, the feature of the person meeting with the user is detected on the basis of the image captured by the video input unit 528 and/or the voice collected by the sound collecting microphone 529 (S406). Then, it is determined whether or not the individual information acquired in S403 is similar to the feature of the person detected in S406 (S407). As a result, if there is no similar information, it is determined that the personal is not the individual information of the other person whom the user is trying to meet or meeting, it returns to the initial state and returns to a state in which it is on standby for new reception from another portable information terminal 458, and if there is similar information, next step is performed, that is, it is determined whether or not the person is similar to the person already accumulated in the storage unit 505 (S408). As a result, if there is no similar information anywhere, the information of the person is newly stored (S409), and if there is similar information in the storage unit 505, the information is updated with the already stored information and accumulated (S410). Thereafter, the information is output to the output unit (for example, the display unit 241) (S411), and the process ends.

Here, as a simple method, S404 to S407 may be deleted, and a method of acquiring the individual information of the user stored in another portable information terminal 458 (S403) and determining whether or not the person is similar to the person already accumulated in the storage unit 505 directly (S408) may be used. This method is suitable for a situation in which the talking partner is limited within a specific region such as, for example, a conference room. However, if it is considered that there are plural persons therearound except for the talking partner, and information is acquired from a plurality of other portable information terminals 458 is made, a method of adding a method of identifying a plurality of persons using S404 to S407 (S404 to S407) is effective.

In FIGS. 19 and 20, the portable information terminal 460 acquires e-mail information from the mobile telephone communication e-mail server 454 via the telephone network communication unit 561 and the base station 453 although not illustrated. The portable information terminal 460 can establish communication with, for example, the application server 456 connected to the public network 457 via the wireless communicator access point 459 through the LAN communication unit 562 or the Wi-Fi communication unit 563 and supply the information of the person stored in the storage unit 505 to the application server 456 or receive information related to the person to be accumulated from the application server 456. Accordingly, it is possible to update the information of the person stored in the storage unit 505.

Here, the accumulated information to be recorded in the storage unit 505 includes date information of a meeting date. Further, in a case in which there is already accumulated information, the updating is performed such that information after the last accumulation date is added.

Further, in FIGS. 19 and 20, in addition to the above-mentioned touch panel 527, for example, the input sensor may determine a case in which the person meeting the user is detected from the image captured by the video input unit 528 as the predetermined situation or determine a case in which the voice information input from the sound collecting microphone 529 is detected to be larger than a predetermined threshold or a case in which a predetermined word as the predetermined situation.

Further, in FIGS. 19 and 20, the process of processing the information output (S307 and S411) after performing the new accumulation (S305 and S409) and the update accumulation (S306 and 410) is described, but the process of processing the information output (S307 and S411) may be performed first, and then the processing step of the new accumulation (S305 and S409) or the update accumulation (S306 and 410) may be performed after providing information to the user. Particularly, in the update accumulation (S306 and 410), it is considered to be desirable that the update accumulation (S306 and 410) be performed using the latest update information after the user adds the information obtained by the conversation with the talking counterpart or the like.

### Eighth Embodiment

In the present embodiment, external configurations of the portable information terminal and the external processing device in the first and second embodiments will be described.

FIG. 21 to FIG. 31 illustrate external configuration diagrams of the portable information terminal and the external processing device in the present embodiment. In FIGS. 21 to 31, components having the same numbers as last two digits of the components in FIGS. 1 to 5 have substantially the same configuration/function as those in FIGS. 1 to 5.

FIGS. 21 and 22 illustrate a wristwatch type portable information terminal to which the portable information terminal 151 or 460 in the first or second embodiment is applied. As illustrated in FIG. 21, it has an outer shape suitable for the user to wear a portable information terminal 2151 (and 2160) on his/her arm and carry it. Basically, the components illustrated in FIGS. 2 and 5 of the first and second embodiments are installed, but only the representative components of FIG. 2 are illustrated in FIG. 22. Therefore, it is possible to install the respective components of FIG. 5 similarly.

In FIG. 22, a portable information terminal 2251 (and 2260) includes a touch panel 2227, a display unit 2241, a video input unit 2228, a sound collecting microphone 2229, a call microphone 2230, an ear speaker 2243, and an ambient speaker 2244. The call microphone 2230 and the ear speaker 2243 are placed on a side closer to the user when the user looks at the clock. Further, the touch panel 2227 is placed on the entire surface of the display unit 2241, and thus the user can perform an input to the touch panel 2227 with a feeling of touching the display surface of the wristwatch.

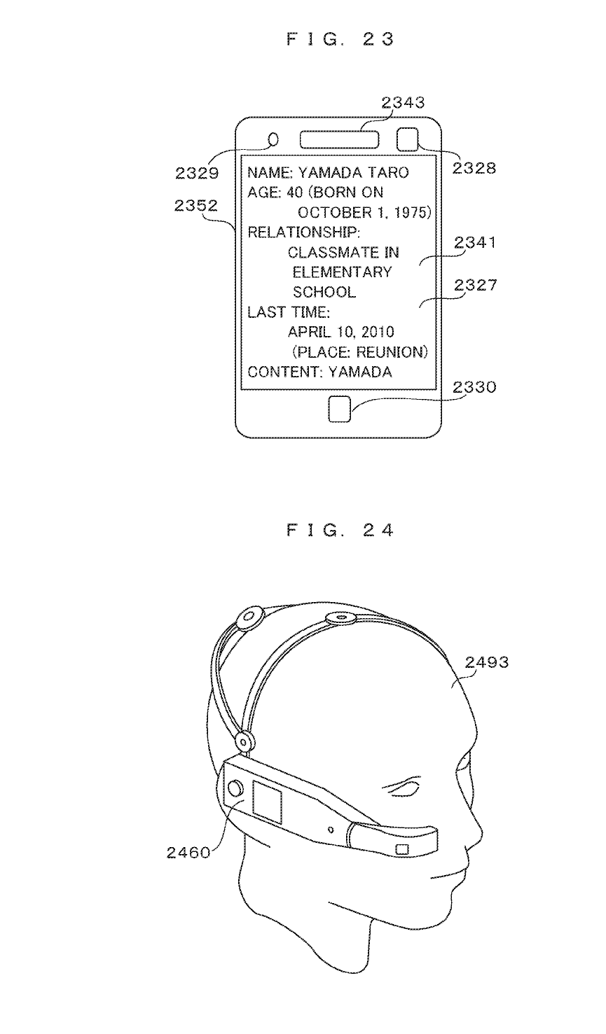

Next, an external layout diagram of the external processing device operating as the external processing device 152 in a case in which the portable information terminals illustrated in FIGS. 21 and 22 operate as the portable information terminal 151 will be described in detail with reference to FIG. 23. As illustrated in FIG. 23, it has an outer shape in which the user carries the external processing device 2352 similarly to a smartphone. Basically, the respective components illustrated in FIG. 3 are installed, but only the representative components of FIG. 3 are illustrated in FIG. 23. In FIG. 23, the external processing device 2352 includes a touch panel 2327, a display unit 2341, a video input unit 2328, a sound collecting microphone 2322, a call microphone 2330, an ear speaker 2334, and an ambient speaker 2344 (which are not illustrated but installed on the back side). The touch panel 2327 is manipulated in a similar manner to a manner of using a smartphone.

Since the display unit 2241 of FIG. 22 has a mall display area, preferably, the display unit 2241 uses the display method illustrated in FIG. 16, and since the display unit 2341 of FIG. 23 has a relatively large display area, the display unit 2341 uses the display method illustrated in FIG. 14.

FIGS. 24 to 27 illustrate external configuration diagrams suitable for, particularly, the portable information terminal 460 of the second embodiment. FIGS. 24 to 27 illustrate the layout of the representative components, and the respective components of FIG. 5 are installed therein. In FIGS. 24 to 27, portable information terminals 2460, 2560, 2660, and 2760, a user 2493, a touch panel 2627, a display unit 2741, a video input unit 2624, 2728, a sound collecting microphone 2629, a call microphone 2730, an ear speaker 2743, and an ambient speaker 2644 are illustrated. In particular, when the portable information terminals 2460, 2560, 2660, and 2760 are used, the display unit 2741 is arranged within the viewing angle of the user 2493. Further, when the user carries the portable information terminal 2460, the call microphone 2730 and the ear speaker 2743 are arranged at appropriate positions. Further, the touch panel 2627 is arranged on the outer surface of the portable information terminal 2660 to be easily manipulated by the user. Further, the video input unit 2628 for imaging the talking partner is arranged on an outer surface, and the video input unit 2728 for imaging the user is arranged on an inner surface.

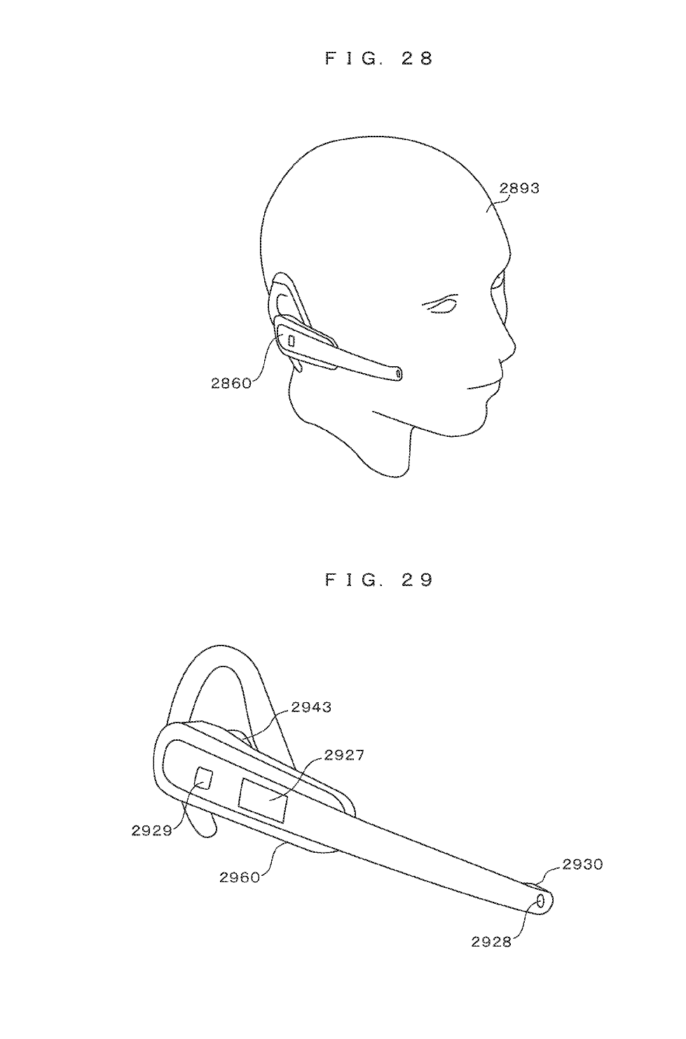

FIGS. 28 and 29 illustrate another example of the external configuration diagram suitable for, particularly, the portable information terminal 460 of the second embodiment. FIG. 28 and FIG. 29 illustrate the layout of representative components used in the use example of the output method by voice, and the respective components of FIG. 5 are installed therein. FIGS. 28 and 29 illustrate portable information terminals 2860 and 2960, a user 2893, a touch panel 2927, a video input unit 2928, a sound collecting microphone 2929, a call microphone 2930, and an ear speaker 2943. In particular, when the portable information terminal 2860 and 2960 are worn and carried, the call microphone 2930 and the ear speaker 2943 are arranged at appropriate positions. Further, the touch panel 2927 is disposed on the outer surface of the portable information terminal 2960 at a position at which the user can easily perform a manipulation

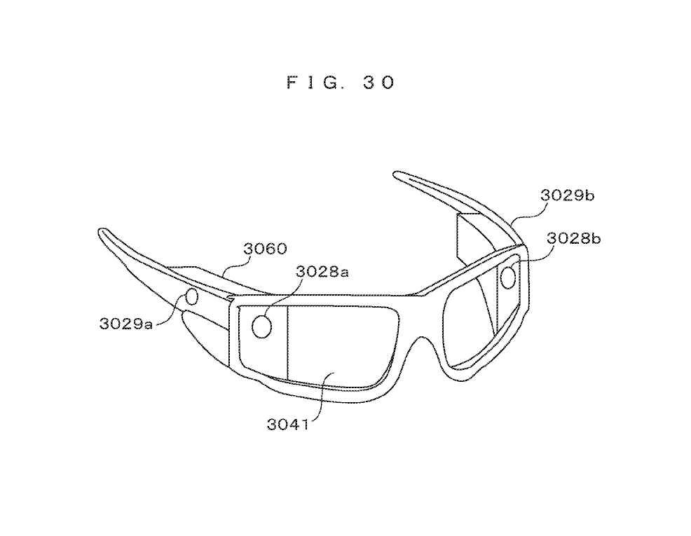

Further, FIG. 30 illustrate another example of the external configuration diagram suitable for the portable information terminal 460 of the second embodiment. FIG. 30 illustrates the layout of representative components used in the use example of the output method by video, and the respective components of FIG. 5 are installed therein. FIG. 30 illustrates a portable information terminal 3060, video input unit 3028a and 3028b, sound collecting microphones 3029a and 3029b, and a display unit 3041. In particular, the video input units 3028a and 3028b and the sound collecting microphones 3029a and 3029b can receive the video and the voice and deal with the video stereoscopically, and thus the accuracy of the person authentication can be improved. When a stereo voice is applied, it is possible to increase the amount of information, and thus a position of a voice source is easily understood, and even when the person authentication is carried out using the video and the voice together, there is an advantage in that technical problems such as extraction of necessary voices are easily solved. Further, when the display unit 3041 employs a transmissive display device, it is possible to simultaneously view the output information of the portable information terminal 3060 and original ambient information.

With the above process, it is possible to provide the function of promptly providing the information of the talking partner of the present invention.

The exemplary embodiments of the present invention have been described above, but the present invention is not limited to the above-described embodiments but includes various modified examples. For example, the above-described embodiments have been described in detail in order to facilitate understanding of the present invention and are not necessarily limited to those having all the components described above. It is also possible to add a configuration of another embodiment to a configuration of an embodiment. It is also possible to perform addition, deletion, and replacement of configurations of other embodiments on a part of the configurations of each embodiment. Further, a sentence of a messages in the description or the drawings is merely an example, and the effects of the present invention are not impaired although a difference sentence is used.

### REFERENCE SIGNS LIST

151, 460, 2151, 2251, 2160, 2260, 2460, 2560, 2660, 2760, 2860,
2960 portable information terminal
152, 2352 external processing device
158, 458 another portable information terminal
159, 459 wireless communication access point
157, 457 public network
156, 456 application server
201, 301, 501 information processing unit
202, 302, 502 system bus
203, 303, 503 ROM
204, 304, 504 RAM
205, 305, 505 storage unit
227, 327, 527 touch panel
241, 341, 541 display unit
228, 328, 528, 2228, 2328, 2628, 2728 video input unit
243, 343, 543, 2243, 2343, 2743, 2943 ear speaker
229, 329, 529 sound collecting microphone
230, 330, 530, 2230, 2330, 2730, 2930 call microphone
310, 510 video storage unit
313, 513 voice storage unit
361, 561 telephone network communication unit
362, 562 LAN communication unit
363, 563 WiFi communication unit
364, 564 Bluetooth communication unit
365, 565 NFC communication unit
671, 983 extraction process
672, 779, 984 person determination
673, 973 accumulation process
775 face contour detection
776 face element detection
778 feature quantity detection
1085 voice interval detection
1086 voice recognition

1. A portable information terminal, comprising:
an input sensor that detects a change in surroundings;
a communication unit that performs transmission and reception of information with an external processing device;
an output unit that outputs information; and
a control unit that detects a predetermined situation from a change in an input signal change from the input sensor, transmits an instruction signal to the external processing device via the communication unit, receives information of a person corresponding to the instruction signal from the external processing device via the communication unit, and outputs the information of the person via the output unit.

2. The portable information terminal according to claim 1, wherein the external processing device includes a video input unit or a voice input unit and has a function of detecting a feature of a person from a signal detected by the video input unit or the voice input unit, and specifying the person in accordance with a result, and
the control unit receives information of a specific person corresponding to the instruction signal from the external processing device.

3. The portable information terminal according to claim 1, wherein the communication unit performs transmission and reception of information with another portable information terminal, and
the control unit detects a predetermined situation from a change in the input signal change from the input sensor, transmits an instruction signal to the other portable information terminal via the communication unit, receives information specifying an owner of the other portable information terminal from the other portable information terminal via the communication unit, and outputs information specifying the owner of the other portable information terminal via the output unit.

4. A portable information terminal, comprising:
a detecting sensor including at least one of a video input unit and a voice input unit;
an output unit that outputs information;
an information accumulating unit; and
a control unit that detects a predetermined situation from a change in an input signal from the detecting sensor, detects a feature of a person from the signal detected by the detecting sensor, determines whether or not there is a person in which the feature of the detected person is similar to data accumulated in the past, newly accumulates information of the person in the information accumulating unit in a case in which there is no similar person as a result of the determination, updates the information of the person in the information accumulating unit in a case in which there is a similar person, and outputs the information of the person via the output unit.

5. The portable information terminal according to claim 4, further comprising,
a receiving unit that receives information of an owner of another portable information terminal from the other portable information terminal,
wherein the control unit determines whether or not there is a person in which the information obtained from the receiving unit is similar to the data accumulated in the past, newly accumulates information of the person in the information accumulating unit in a case in which there is no similar person as a result of the determination, and updates the information of the person in the information accumulating unit in a case in which there is a similar person.

6. The portable information terminal according to claim 4, further comprising,
a receiving unit that receives information of an owner of another portable information terminal from the other portable information terminal,
wherein the control unit extracts a feature of a person from the signal detected by the detecting sensor, determines whether or not information of the owner of the other portable information terminal from the receiving unit is similar to the extracted feature of the person, newly accumulates information of the person in the information accumulating unit in a case in which there is no similar person as a result of the determination, and updates the information of the person in the information accumulating unit in a case in which there is a similar person.

7. The portable information terminal according to claim 6, further comprising:
a connecting unit that establishes a connection with an external network;
a transmitting unit that transmits the information of the person accumulated in the information accumulating unit to a server connected to the network via the connecting unit; and
a server information receiving unit that receives the information of the owner received from another portable information terminal from the server,
wherein the information accumulating unit updates the information of the person on the basis of the information of the owner from the server information receiving unit.

8. The portable information terminal according to claim 6, wherein the information of the information accumulating unit includes at least date information at which information of a person is newly obtained.

9. The portable information terminal according to claim 8, wherein, in a case in which there is a similar person as a result of the determination, update information after a date of information which is accumulated last time is received from the other portable information terminal.

10. The portable information terminal according to claim 4, wherein as the information of the person to be output, voice information of a user of the portable information terminal is extracted from the detecting sensor, and output information is selected in accordance with the voice information of the user.

11. The portable information terminal according to claim 3, wherein the input sensor is constituted by a communication unit that performs transmission and reception of information with the other portable information terminal.

12. The portable information terminal according to claim 1, wherein the information of the person to be output includes at least one of a name, an age, a relationship with the user, a date and time of a previous meeting, and conversation content at the previous meeting.

13. An information processing method of a portable information terminal, comprising:
an input step of detecting a change in surroundings;
a transmission step of detecting a predetermined situation from a change in an input signal in the input step and transmitting an instruction signal to an external processing device;
a reception step of receiving information of a person corresponding to the instruction signal from the external processing device; and
an output step of outputting the information of the person obtained in the reception step.

14. The information processing method of the portable information terminal according to claim 13, wherein the external processing device includes a video input unit or a voice input unit and has a function of detecting a feature of a person from a signal detected by the video input unit or the voice input unit, and specifying the person in accordance with a result, and
information of a specific person corresponding to the instruction signal is received from the external processing device.

15. The information processing method of the portable information terminal according to claim 13, further comprising:
a transmission step of detecting a predetermined situation from a change in an input signal in the input step and transmitting an instruction signal to another portable information terminal;
a reception step of receiving information specifying an owner of the other portable information terminal from the other portable information terminal; and
an outputting step of outputting the received information specifying the owner.

16. The information processing method of the portable information terminal according to claim 15, wherein as the information specifying the owner in the output step, voice information of a user of the portable information terminal is extracted in the input step, and output information is selected in accordance with the voice information of the user.

17. The information processing method of the portable information terminal according to claim 15, wherein the input step includes a reception step of receiving information from the other portable information terminal.

18. The information processing method of the portable information terminal according to claim 15, wherein the information specifying the owner in the output step includes at least one of a name, an age, a relationship with the user, and a year, a month, and a date of a previous meeting, and conversation content at the previous meeting.
